(19) United States
(12) Patent Application Publication
(10) Pub. No.: US 2002/0052216 A1
(43) Pub. Date: May 2, 2002

(54) Wireless telephone with acoustic speaker coupling

(76) Inventor: Chang June Song, Richmond (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/827,881

(22) Filed: Apr. 4, 2001

Related U.S. Application Data
(60) Provisional application No. 60/244,960, filed on Oct. 30, 2000.

(51) Int. Cl. H04M 1/00

(52) U.S. Cl. 455/550; 455/569; 455/575

(57) ABSTRACT

A wireless phone is constructed so that the speaker assembly is located at a location remote from the ear of a user. An acoustic tube has an inlet that connects to the speaker and an outlet that is positioned proximate an opening that operates as the earpiece of the telephone. Aural energy produced by the speaker assembly is captured by the inlet, communicated by the tube to the outlet and passed to the opening for a user to perceive.

### CROSS-REFERENCES TO RELATED APPLICATIONS

This application claims priority to co-pending U.S. Provisional Patent Application No. 60/244,960, filed Oct. 30, 2000, the disclosure of which is incorporated herein by reference in its entirety for all purposes.

### BACKGROUND OF THE INVENTION

The present invention relates to telecommunication equipment, and more particularly to a wireless telephone in which the speaker is remotely located within the shell of the wireless telephone with the aural energy produced by the speaker communicated to an outlet by a acoustic tube.

Wireless telephones, including cell phones, are a common commodity today. Cell phones, for example, can provide instant communicative access, allowing one to contact almost whoever they want, whenever they want, wherever they are. Unfortunately, the convenience of wireless telephones may come at a price. There are increasing concerns about certain health hazards associated with wireless phone use. Even though the energy emanating from the phone (e.g., the antenna, speaker area, etc.) is relatively small, there is mounting evidence to support these concerns, suggesting that the close proximity of such sources of electromagnetic radiation (“EMR”) to a user's head may can cause tumors to form on the brain, or cause other genetic damage. Nervousness about the harmful potential of microwaves, which at a distance are considered harmless, but when close the head, and particularly the ear canal and the pathway it forms to the brain, are more worrisome. These concerns have caused the FCC to regulate the amount of energy that wireless phones are allowed to emit.

The industry continues to maintain that all cell phones sold in the United States meet government regulations and are safe, and recent studies tend to bear this out. However, critics continue to claim that studies implying the safety of wireless phones are flawed, and many sources continue to be troubled about the energy emitted by wireless telephones. This continuing concern has prompted the Cellular Telecommunications Industry Associates (“CTIA”) to require those cell phone manufacturers who wish to be certified by CTIA to submit radiation data.

A particularly worrisome source of EMR from a wireless telephone is believed to be the speaker assembly due to its close proximity to the ear and ear canal of a user. RF energy produced by the certain of the circuitry of a wireless telephone (e.g., the oscillator and transmitter sections) is believed picked up by the speaker wiring and transmitted to the user when the wireless telephone is in use. The worry is that the close proximity of this source of EMR, i.e., the speaker, to the head, ear, ear canal, and brain of a user presents a significant danger.

Thus, there appears a need for a wireless telephone construction that is less harmful to users than is available today.

### SUMMARY OF THE INVENTION

The present invention is directed to a wireless telephone that is believed safer than theretofore available. What is believed to be a major source of EMR, the speaker assembly, is moved to a location in the wireless telephone that is further away from the head of a user.

Broadly, the invention is directed to relocating the speaker assembly of a wireless telephone from its usual location, near the speaker grate or earpiece formed in the case of the telephone, to the end of the of the telephone farthest from the telephone earpiece. An acoustic link attaches to the speaker assembly to capture the acoustic energy produced and transmit that aural energy to the earpiece.

In a preferred embodiment of the invention the acoustic link, including the tube, are fabricated from an electrically non-conducting material.

A number of advantages are found in the present invention, principal of which is that locating the speaker assembly, a possible source of EMR energy, away from the ear and ear canal of a user, will, it is believed, result in a reduction of the amount of EMR encountered by user when using the telephone. RF energy increases or decreases according the square of the distance from the source of that energy. Thus, moving the speaker assembly, which is believed to be one source of EMR, further from the head, ear, and ear canal of a user greatly reduces the risk of EMR-induced injury.

These and other objects and advantages of the invention will become apparent to those skilled in this art upon a reading of the embodiments of the invention described below, which should be taken in conjunction with the accompanying drawings.

### BRIEF DESCRIPTION OF THE DRAWINGS

FIG. 1 is a front view of a wireless telephone showing, in phantom, an acoustic coupling to communicate sound produced by a remotely-located speaker assembly to a sound outlet in accordance with the present invention;

FIG. 2 is a side sectional view of the wireless telephone of FIG. 1, taken along the lines 1-1;

FIG. 3 is an exploded view of the acoustic link shown in FIG. 1 used to convey sound from the remotely-located speaker assembly to the outlet;

FIG. 4 is a wireless telephone showing an alternate embodiment of the present invention;

FIGS. 5A, 5B, and 5C illustrate a construction of a channel formed to convey audio energy from a remotely located speaker assembly to a broadcast cone

FIG. 6 is a sectional view taken along lines 6-6 of FIG. 5A;

FIG. 7 s a sectional view taken along lines 7-7 of FIG. 5A;

FIG. 8 shows the present invention incorporated in a flip-top wireless telephone; and

FIG. 9 is an exploded view of the acoustic link to convey sound in the flip-top wireless telephone shown in FIG. 8.

### DESCRIPTION OF THE EMBODIMENTS OF THE INVENTION

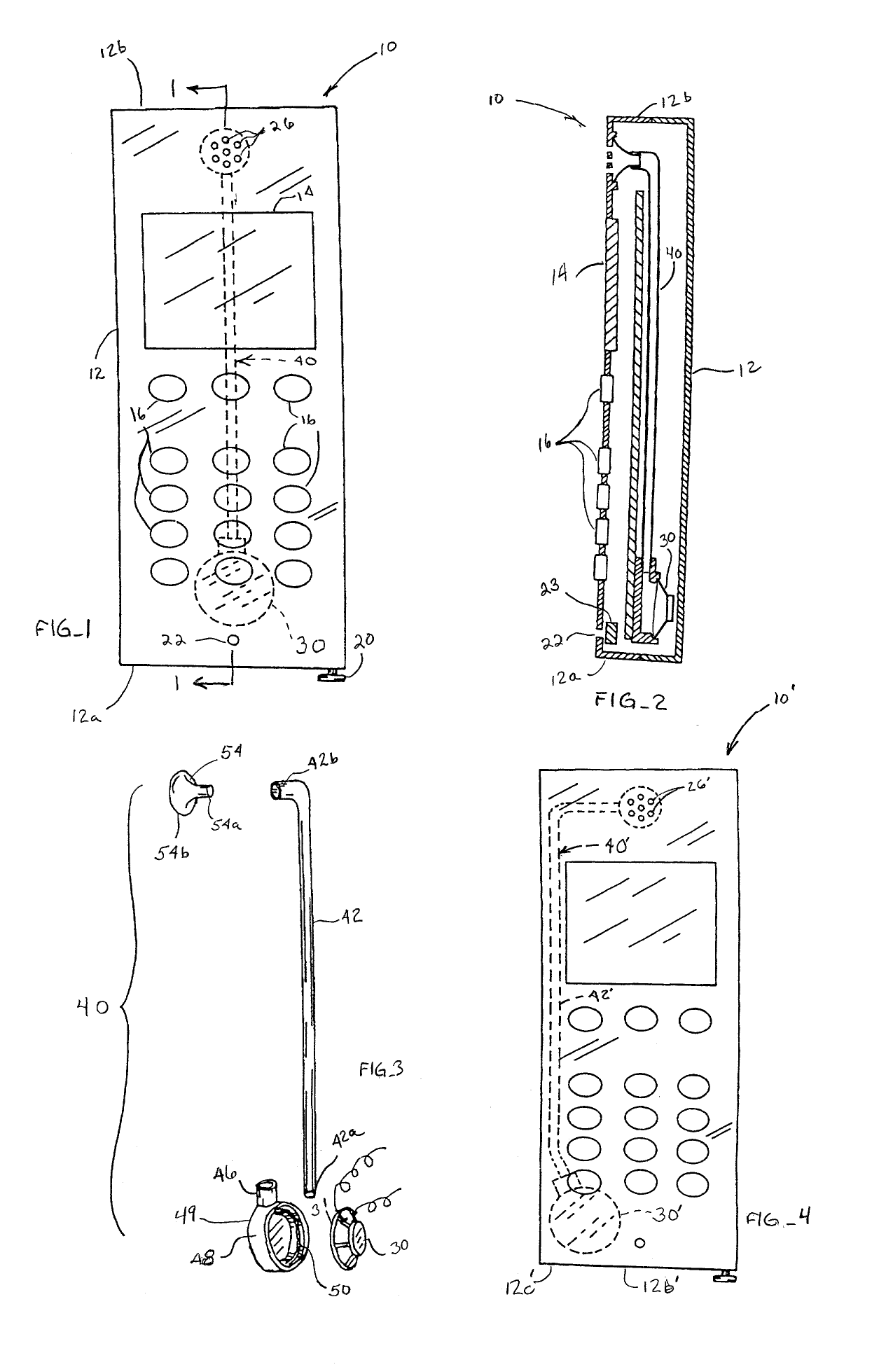

Turning now to the Figures, and for the moment specifically FIGS. 1 and 2, there is illustrated a wireless telephone incorporating the present invention. As FIG. 1 shows, a wireless telephone, designated generally with the reference numeral 10, includes a case or housing 12 to contain the operating elements of the wireless telephone 10 such as the transmitter, receiver, oscillator (not shown). As is conventional with some wireless telephones, a display 14 is mounted in the case 12 to display such information as the being called number, or even email messages. Keys 16, which may be finger depressible, touch-sensitive, or any other type of key, form a keypad for information entry. At one end 12a of the case is mounted a telescopic antenna 20. Also, proximate the end 12a, is a microphone orifice 22 to permit sound energy produced by a user to pass through the case 12 to a microphone 23 (FIG. 2) of the wireless telephone 10.

Formed in the case 12 at the other end 12b of the wireless telephone 10 is a number of apertures 26 that create or form an earpiece of the telephone, providing an outlet from the case for acoustic energy generated by a speaker assembly 30 and communicated thereto by an acoustic link 40 (described and discussed below).

The speaker assembly 30 may be of conventional design, and as FIGS. 1 and 2 show, is located remotely from the apertures 26, near the end 12a of the case 12. The reason for this remote location of the speaker 30 is to reduce the EMR energy to which a user's head may be exposed. Since RF energy diminishes by the square of the distance between its source and the point of concern, re-locating the speaker assembly from its conventional location proximate the apertures 26 away from those apertures is believed to reduce the amount of EMR to which a user's head, and in particular ear canal, will encounter which the wireless telephone 10 is in use.

In accordance with the present invention, an acoustic link 40 is used to communicate the acoustic energy produced the speaker assembly 30 to the earpiece formed by the apertures 26. Thereby, this arrangement allows placement of the speaker assembly 30 away from the earpiece apertures 26 that are located proximate the end 12b of the wireless telephone 10. As shown in phantom in FIG. 1, and as better seen in FIGS. 2 and 3, the acoustic link 40 comprises a hollow tube 42. One end 42a of the tube 40 is shaped and dimensions for snug insertion (to minimize acoustic leak) in a collar 46 of a speaker cup 48. The speaker cup 48 is shaped and constructed to receive the speaker assembly 30. The speaker cup 48 has formed internal thereof an annular shoulder 50 upon which the rim 31 of the speaker assembly 30 will rest when inserted in the recess of the speaker cup 48. The shoulder 50 prevents further insertion of the speaker assembly 30 into the interior of the speaker cup 48 in order to locate it, relative to a backwall 49, for create a space between the diaphragm of the speaker assembly 30 and the backwall 49 is created. The collar 46 is positioned to open to the space so created, and communicate that space to the tube 42 when connected to the end 42a of the collar 46.

The other end 42b of the tube 42 is formed to receive a funnel-shaped broadcast horn 54 having a smaller end 54a configured to snuggly fit in the opening of the end 42b, and a larger open end 54b that is positioned proximate the earpiece apertures 26.

It will be appreciated by those skilled in this art that the wireless telephone 10 will also include numerous other elements for phone operation, such as the oscillator, transmitter, and receiver electronics, and even the connections to the speaker assembly 30, microphone 22, keys 16, or display 14. These other elements are not shown in order to keep from unduly complicating the illustration and description of the invention.

When assembled, as shown in FIGS. 1 and 2, the speaker cap 48 of the acoustic link 40 will have mounted therein the speaker assembly 30 to capture the acoustic energy produced by the speaker when the wireless telephone is in operation. That acoustic energy is captured by the space within the speaker holder 48 between the speaker assembly and the backwall 49, and passed through the collar 46 and to the tube 42. The tube will, in turn, convey that energy to the horn 42 where the sound contained in that energy is communicated to and through the earpiece apertures 26. A user, by placing her/his ear in close proximity to the apertures 26, can thereby hear the sound produce by the speaker assembly 30 without fear of being exposed to high EMR emissions.

Preferably, the elements of the acoustic link, or at least the tube 42 and the horn 44, are made of an electrically non-conductive material in order to inhibit transmission of EMR energy.

FIG. 4 shows a wireless telephone 10′ with substantially the same construction as that of the wireless telephone 10 illustrated in FIGS. 1 and 2, except that a speaker assembly 30′ is located in a corner 12c′ of the end 12a′ of the wireless telephone 10′. With the speaker assembly so located, an acoustic link 40′, including a tube 42′, is shaped and constructed to form an pathway from the speaker assembly 30′ to the earpiece apertures 26′ where the aural energy conveyed from the speaker assembly 30′ is emitted.

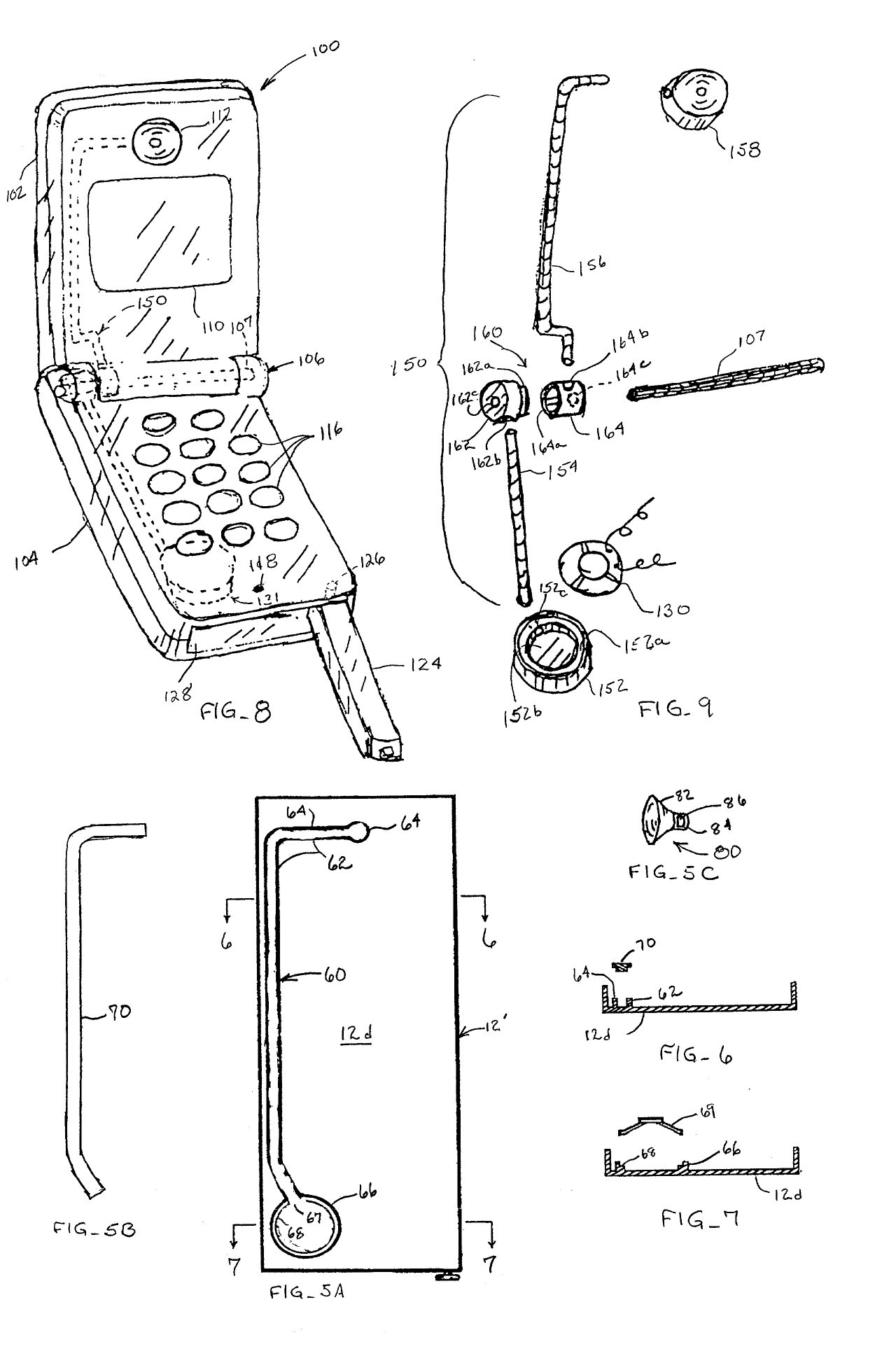

FIGS. 5, 6 and 7 show an alternative to the construction of the acoustic link 40 illustrated in FIGS. 1-4. As FIGS. 5A and 6 show, a channel 60 is constructed on the backwall 12d of the wireless telephone 12′ by upright (relative to the backwall 12d), spaced channel walls 62, 64, forming on the backwall 12d a pathway from a circular connection point 64 to a speaker mount 66. As better seen in FIG. 7, the speaker mount 66 includes an interior, annular shoulder 68 that holds the speaker assembly 69 in spaced relation from the back wall 12d to form a collection area for acoustic energy produced by the speaker assembly represented at 69.

A cover 70 is formed and configured to mateably fit in the channel walls 62, 64 to enclose the channel 60. The acoustic energy collected at the speaker mount 66 is passed from the speaker mount to the channel 60 through an opening 67 (FIG. 5A) formed in the speaker mount 66 The channel 60 then conveys that energy to the connection point 64. A broadcast cone 80 (FIG. 5C) includes a conical section 82 and a barrel-shaped end 84 that is apertured at 86. The end 84 of the broadcast cone 80 is configured to be received and snuggly held by the connection point 84. With the aperture at 86 positioned to receive the sound conveyed by the channel 60, the broadcast cone 80 operates to broadcast the energy conveyed by the channel 60 through the earpiece apertures 26′ and to the user.

An advantage of the channel 60 construction is that it can be manufactured during manufacture of the case of the wireless telephone, thereby reducing manufacturing costs.

The wireless telephone designs illustrated in FIGS. 1-5 incorporating the invention have been unitary construction; that is, the case 12 is essentially one piece. However, as those in this art are readily aware, many present wireless telephone designs use two-piece constructions, sometimes referred to as “flip-phones,” in which a first is hingedly connected to open away from a second part for use. a representative flip-phone construction is generally illustrated in FIG. 8. As seen in FIG. 8, a wireless telephone 100 comprises two phone sections 102 and 104 hingedly attached to one another at 106 by a hinge shaft 107. As is conventional in such flip-phone telephone, the section 102 of the wireless telephone 100 carries a display screen 110 and an earpiece aperture 112. The earpiece aperture 112 is formed here by a single aperture, although multiple apertures can be used such as was shown in connection with FIGS. 1-2 and 4.

The section 104 of the wireless telephone 100 carries the input keys 116, a microphone aperture 118 to permit sound to pass to a microphone (not shown). The section 104 may also carry an antenna arrangement that comprises an antenna case 124 for containing an antenna for transmission and reception of RF energy. The antenna case 124 is pivotally attached to the second phone section 104 at 126 to be received by or removed from a recess 128 that houses the antenna case 124 when the wireless telephone 100 is not in use.

According to the present invention a speaker assembly 130 (FIG. 9), shown generally at 131 in FIG. 8, is located in the second section 104 of the wireless telephone 100 rather than where located in prior designs, i.e., in close proximity to the earpiece aperture 112. Then, to communicate sound to the earpiece aperture 112, an acoustic link 150, similar in design to the acoustic link 40 discussed above, is provided.

As better seen in FIG. 9, the acoustic link 150 includes a speaker cap 152, a first hollow tube 154, a second hollow tube 156, a broadcast horn 158, and an acoustic connector 160, including connector parts 162, 164, that operate to acoustically join the hollow tubes 154 and 156 to one another.

The speaker cap 152 is substantially similar to the speaker cap 48 of the wireless telephone 10 (FIGS. 1-4), and as such is recessed to receive the speaker assembly 130 in much the same way. Like speaker cap 48, speaker cap 152 has formed therein a shoulder 152a to hold the speaker assembly in the recess in spaced relation to the backwall 152b. The circumference of the speaker cap 152 is apertured at 152c to received and communicate the hollow tube 154 with the space in the recess between the speaker assembly 130 and the backwall 152b.

The acoustic connector 160 allows the two tubes 154, 156 to move with the respective sections 102, 102, when the wireless telephone 100 is opened for operation, or closed. The two connector parts 162, 164 of the acoustic connector 160 are cylindrically shaped, and the connector part 162 has a short extension 162a sized to be movably received and held in a recessed section 164a of the connector part 164. The connector part 162 is apertured at 162b to receive a terminus of the tube 154, and similarly, the connector part 162 is apertured at 162b to receive a terminus of the hollow tube 154.

Both connector parts 162, 164 are apertured at 162c, 164c, respectively, to receive the hinge shaft 107 that pivotally holds the first and second sections 102, 104 together. The hinge shaft 107 also runs through the apertures 162c, 164c formed in the connector parts 162, 164, holding them in concentric engagement. As FIG. 9 illustrates, the connector parts 162, 164 are hollow, so that when joined together, a chamber is formed to communicate the hollow tubes 154, 156 to one another.

The acoustic link 150, when assembled, functions to forms an acoustic path from the speaker assembly 130, installed in the speaker holder 152, to the broadcast horn 158. There, the broadcast horn 158 transmit the aural energy generated by the speaker assembly 130 through the earpiece aperture to a user. Like the embodiment of FIGS. 1-4, the embodiment of FIGS. 5-6 re-locates the speaker assembly 130 from its prior location proximate the earpiece to a safer location insofar as EMR emissions encountered by a person when the wireless telephone 100 is used.

Preferably, the components of the acoustic link 150, including the speaker cap 152, the acoustic connector 160, and the horn 158, are fabricated from an electrically nonconductive materials to reduce the EMR carried thereby.

What is claimed is:

1. A wireless telephone, including:
a case having first and second ends and containing a speaker;
a microphone situated proximate the first end;
an opening in the case located proximate the second end; and
a tube coupled to the speaker and having an outlet positioned proximate the opening to communicate aural energy produced by the speaker to the opening for egress therefrom.

2. The wireless telephone of claim 1, including a cap shaped and configured to receive sound energy produce by the speaker, the cap being coupled to the tube to convey the aural energy thereto.

3. The wireless telephone of claim 1, wherein the speaker is located in the case near the first end.

4. The wireless telephone of claim 2, wherein the tube is fabricated of electrically non-conductive material.

5. The wireless telephone of claim 1, including a horn attached to the outlet of the tube, the horn having an exit situated to broadcast aural energy received from the tube to the opening.

6. The wireless telephone of claim 5, wherein the tube and the horn are fabricated of electrically non-conductive material.

7. The wireless telephone of claim 6, wherein the horn is shaped to have an first opening to connect to the tube and a widening to second opening larger than the first opening.

8. A wireless telephone having first and second sections pivotally joined to one another, and including
a microphone and a speaker mounted in the first section, the second section having formed therein an opening for passage of aural energy produced by the speaker;
an acoustic tube having an input coupled to receive aural energy produced by the speaker assembly and an output positioned proximate the opening to present aural energy conveyed from the speaker thereto.

9. The wireless telephone of claim 8, including a speaker cap coupled to receive aural energy produced by the speaker assembly, the input for communication to the inlet of the acoustic tube.

10. The wireless telephone of claim 9, the tube including first and second sections respectively forming the inlet and the outlet and joined by an acoustic coupling that conveys aural energy from the first section to the second section, the acoustic coupling adapted to allow the first and second sections to pivot relative to one another.

11. The wireless telephone of claim 8, wherein the acoustic tube is fabricated from a non-conductive material.

12. The wireless telephone of claim 10, wherein at least the second section is formed from an electrically non-conductive material.

13. The wireless telephone of claim 1, wherein the case includes a backwall extending between the first and second ends, and the tube is formed by a pair of spaced channel walls and a top to form an enclosure for communicating the aural energy.
